(19) United States
(12) Patent Application Publication
(10) Pub. No.: US 2011/0123840 A1
(43) Pub. Date: May 26, 2011

(54) Secondary battery

(76) Inventors: Woon-Seong Baek, Suwon-si (KR); Heui-Sang Yoon, Suwon-si (KR); Sang-Joo Lee, Suwon-si (KR); Woody Kim, Suwon-si (KR)

(21) Appl. No.: 12/923,245

(22) Filed: Sep. 10, 2010

(30) Foreign Application Priority Data
Nov. 23, 2009 (KR) 10-2009-0113244

(51) Int. Cl. H01M 10/42

(52) U.S. Cl. 429/7

(57) ABSTRACT

A secondary battery includes a bare cell, a protective circuit module, a lead plate connecting the protective circuit module with the bare cell, and a cap plate in a top of the bare cell, the cap plate including at least one clad metal layer.

### BACKGROUND

1. Field

Example embodiments relate to a rechargeable battery. More particularly, example embodiments relate to a secondary battery in which a bare cell and a protective circuit module are connected to each other via a reinforced cap plate.

2. Discussion of Related Art

In general, a rechargeable battery, i.e., a battery which can be repetitively used through charging, may be used as a power supply of an electronic apparatus, e.g., for communication, information processing, and/or multimedia. For example, the secondary battery may be environmentally friendly, and may be used as a power supply having ultra-light weight, high energy density, high output voltage, low self-discharge rate, and long life-span.

The secondary battery may be classified into a nickel metal hydride (Ni-MH) battery and a lithium ion (Li-ion) battery in accordance with an electrode active material. For example, the lithium ion battery may further be classified into a case using a liquid electrolyte and a case using a solid polymer electrolyte or a gel-type electrolyte in accordance with the type of the electrolyte. In another example, the lithium ion battery may be classified into various types, e.g., a can type, a pouch type, etc., in accordance with the type of a container housing an electrode assembly.

### SUMMARY

Embodiments are directed to a rechargeable battery, which substantially overcomes one or more of the problems due to the limitations and disadvantages of the related art.

It is therefore a feature of an embodiment to provide a secondary battery with a cap plate having a reinforced rigidity by using a clad metal layer in the cap plate.

It is therefore another feature of an embodiment to provide a secondary battery with a cap plate between a bare cell and a protective circuit module, thereby strengthening a connection therebetween.

It is yet another feature of an embodiment to provide a secondary battery in which a thickness of a pack and the number of components are reduced by forming a cap plate by a clad metal layer, thereby achieving process simplification.

It is still another feature of an embodiment to provide a method o forming a secondary battery having one or more of the above features.

At least one of the above and other features and advantages may be realized by providing a rechargeable battery, including a bare cell, a protective circuit module, a lead plate electrically connecting the protective circuit module with the bare cell, and a cap plate formed on the top of the bare cell, wherein the cap plate includes a clad metal layer.

The lead plate may be connected to the bare cell via the clad metal layer of the cap plate. The lead plate and the clad metal layer of the cap plate may include a substantially same material. The clad metal layer may include lower and upper layers formed of different materials, the upper layer contacting the lead plate and including a substantially same material as the lead plate. The clad metal layer may completely overlap a portion of the lead plate contacting the cap plate.

The clad metal layer may be formed at a portion to which the lead plate is connected, and the cap plate may include an aluminum metal layer and may be formed throughout the whole surface of the top of the bare cell. The cap plate may be constituted by two or more metal layers, and each of the layers may be constituted by the clad metal layer made of metals having different materials.

The clad metal layer of the cap plate may include an aluminum metal layer and an additional metal layer on the aluminum metal layer, the aluminum metal layer overlapping an entire top of the bare cell. The aluminum metal layer may be between the additional metal layer and the bare cell, and the additional metal layer including a different metal than aluminum. The lead plate may be connected to the additional layer, the lead plate and the additional layer including a substantially same material. The additional layer may overlap an entire portion of the lead plate contacting the cap plate. The additional metal layer may completely overlap the aluminum layer. The cap plate may include an upper metal layer formed by a nickel metal layer and a lower metal layer formed by the aluminum metal layer. The lead plate may be connected onto the top of the clad metal layer, and the upper metal layer, which is the top of the clad metal layer and the lead plate, may be made of the same material.

The lead plate may be an anode lead plate, and one side of the lead plate may be connected to the protective circuit module and the other side may be connected to the top of the clad metal layer. Both sides of the anode lead plate may be connected with the protective circuit module and the clad metal layer by a welding method.

The secondary battery may further include a coupling case covering the top of the bare cell, the protective circuit module, and the lead plate. The secondary battery may further include a cathode lead plate of which one side is connected to an electrode terminal of the bare cell and the other side is connected with the protective circuit module.

At least one of the above and other features and advantages may be realized by providing a method of forming a rechargeable battery, including forming a bare cell, forming a protective circuit module, electrically connecting a lead plate between the protective circuit module and the bare cell, and forming a cap plate on a top of the bare cell, wherein the cap plate includes a clad metal layer.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a perspective view of an assembled secondary battery according to an embodiment;

FIG. 2 illustrates an exploded perspective view of a secondary battery according to an embodiment;

FIG. 3 illustrates a coupling diagram of a bare cell and a cap plate according to an embodiment;

FIG. 4 illustrates a partial cross-sectional view of a secondary battery of FIG. 1 along line I-I; and

FIG. 5 illustrates a cross-sectional view of a bare cell according to an embodiment.

### DETAILED DESCRIPTION

Korean Patent Application No. 10-2009-0113244, filed on Nov. 23, 2009, in the Korean Intellectual Property Office, and entitled: “Rechargeable Battery” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Also, it will also be understood that when an element is referred to as being “connected to” another element, it can be directly connected to the other element, or be indirectly connected to the other element with one or more intervening elements interposed therebetween. Like reference numerals refer to like elements throughout.

Hereinafter, embodiments of a secondary battery according to an embodiment will be described in detail with reference to the accompanying drawing figures.

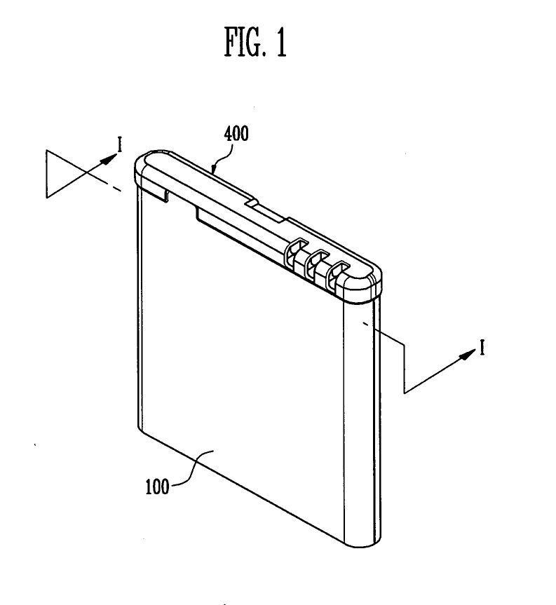

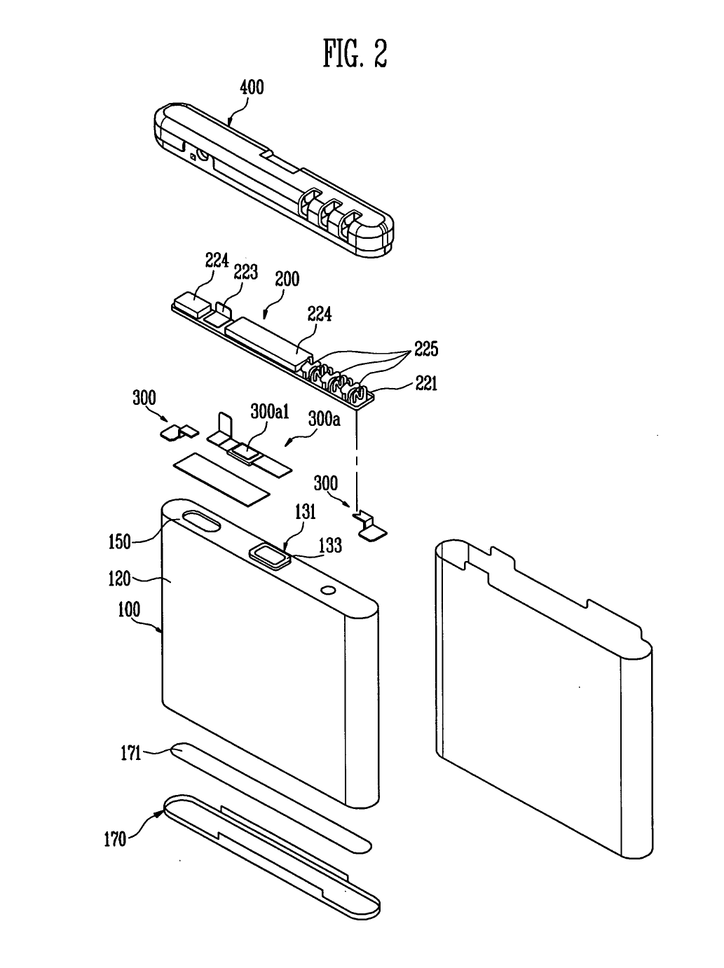

Referring to FIGS. 1 and 2, a secondary battery according to an embodiment may include a bare cell 100, a protective circuit module 200 electrically connected with the bare cell 100, a lead plate 300 electrically connecting the protective circuit module 200 with the bare cell 100, and a coupling case 400 covering the top of the bare cell 100, the protective circuit module 200, and the lead plate 300, as illustrated in FIGS. 1 to 3. Further, the secondary battery may include a cap plate 150, e.g., including a clad metal, in an upper part of the bare cell 100. The bare cell 100 with the cap plate 150 will be described in more detail below with reference to FIG. 5.

Referring to FIG. 5, the bare cell 100 may include an electrode assembly 110, a can 120 housing the electrode assembly 110, and a can assembly 130 sealing an upper opening portion of the can 120. The cap plate 150 may be in an upper portion of the can assembly 130.

The electrode assembly 110 may be formed by laminating and winding an anode plate 111 applied with an anode active material, a cathode plate 112 applied with a cathode active material, and a separator 113 interposed between the anode plate 111 and the cathode plate 112. In the anode plate 111, an anode tab 114 may be electrically connected to an area of an anode collector where the anode active material is not formed. In the cathode plate 112, a cathode tab 115 may have a curved portion having a zigzag shape and may be electrically connected to an area of a cathode collector where a cathode active material is not formed. An insulating tape (not shown) for preventing short-circuit between the electrode tab and the anode/cathode electrode plates 111 and 112 may be rolled on a boundary portion where the anode tab 114 and the cathode tab 115 are drawn out from the electrode assembly 110. Further, a width of the separator 113 may be larger than those of the anode plate 111 and the cathode plate 112, thereby preventing a short-circuit therebetween.

As further illustrated in FIG. 5, an insulating case 140 may be installed above the electrode assembly 110, e.g., between the cap assembly 130 and the electrode assembly 110, in order to electrically insulate the electrode assembly 110 and the can assembly 130 and to cover an upper end portion of the electrode assembly 110. The insulating case 140 may be made of, e.g., a polymer resin having an electrical insulating property. Further, a through-hole may be formed at a center of the insulating case 140 to pass the cathode tab 115 therethrough, and an electrolytic solution passing hole 141 may be formed at a side of the insulating case 140.

The can 120 may house the electrode assembly 110, and may be made, e.g., of aluminum or an aluminum alloy. The can 120 may have any suitable shape, e.g., a substantially rectangular parallelepiped shape. The electrode assembly 110 may be inserted into the can 120 through an open upper end of the can 120, such that the can 120 may serve as a container for the electrolytic solution. Further, the can 120 may serve as a terminal.

The can assembly 130 may be provided to seal the can 120. The can assembly 130 may include the cap plate 150, e.g., a flat-type plate having a size and a shape corresponding to the open upper end of the can 120. The cap assembly 130 may further include a terminal through-hole 132a in a center of the cap plate 150, so an electrode terminal 131 may penetrate the terminal through-hole 132a to contact the cathode tab 115. The cap assembly 130 may further include a tube-shaped gasket 133 installed between the electrode terminal 131 and the cap plate 150 for electrical insulation. Further, an insulating plate 134 may be disposed on a bottom of the cap plate 150 to insulate the cap plate 150 from a terminal plate 135 installed on a bottom of the insulating plate 134. Further, the electrode terminal 131 may be electrically connected with the terminal plate 135. The anode tab 114 drawn out from the anode plate 111 may be connected, e.g., welded, onto the bottom of the cap plate 150.

An electrolytic solution inlet 132b may be formed at one side of the cap plate 150, so the electrolytic solution may be injected therethrough. A plug 132c for hermetically sealing the electrolytic solution inlet 132b may be installed. For example, the plug 132c may be a ball-type mold made of, e.g., aluminum or aluminum-containing metal, and mechanically laid on and pressed to the electrolytic solution inlet 132b. Further, the plug 132c may be welded to the cap plate 150 in the vicinity of the electrolytic solution inlet 132b for hermetical sealing. A safety vent 132d may be formed at the other side of the cap plate 150, i.e., a side opposite the electrolytic solution inlet 132b. When the pressure in the battery increases up to predetermined pressure or higher, the safety vent 132d may be broken to relieve the pressure and prevent the battery from firing and exploding.

The cap plate 150 may be provided in the upper part of the bare cell 100, as shown in FIGS. 3-5. For example, the cap plate 150 may be formed throughout the whole surface of the top of the bare cell 100, e.g., overlap and cover an entire opening of the can 120 with the exception of openings 132a, 132b, and 132d, or at a portion to which the lead plate 300 is connected.

The cap plate 150 may include clad metal, e.g., a metal composite including at least two different metal layers. The cap plate 150 may include two or more metal layers. For example, the cap plate 150 may include a plurality of metal layers formed of different materials and combined into a single clad metal layer. In another example, each metal layer in the cap plate 150 may be a clad metal layer formed by combining, e.g., into a composite, two or more kinds of metals having different properties, e.g., through hot rolling, cold rolling, or explosive welding. The clad metal layer may be used to form the entire cap plate 150 or only portions thereof. For example, the entire cap plate 150 covering the entire opening of the can 120 may be formed of clad metal. In another example, when the entire cap plate 150 covers the entire opening of the can 120, only a portion of the cap plate 150 contacting, e.g., directly, the lead plate 300 may include clad metal. In yet another example, when the clad metal layer includes an aluminum metal layer, the clad metal layer may be formed on, e.g., only on, a front surface of the cap plate 150.

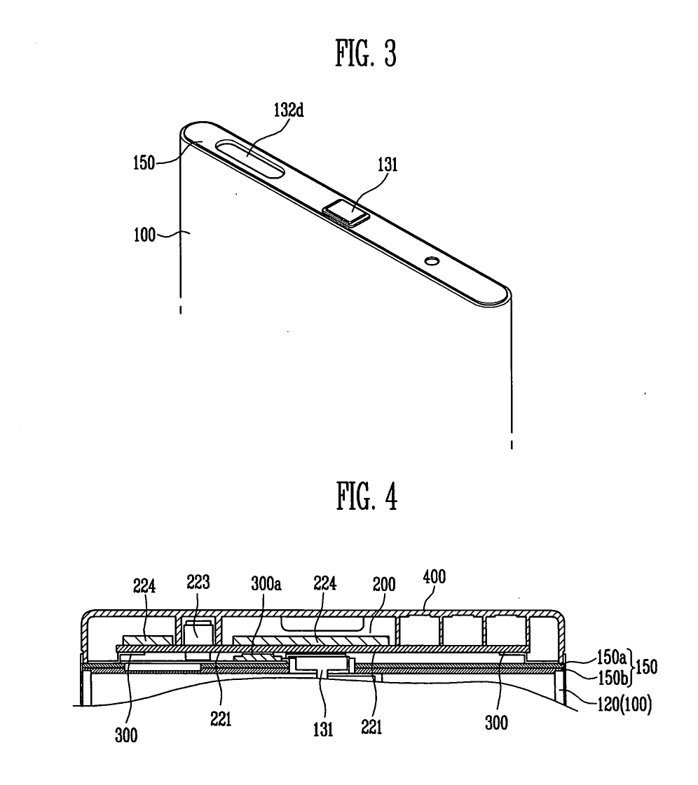

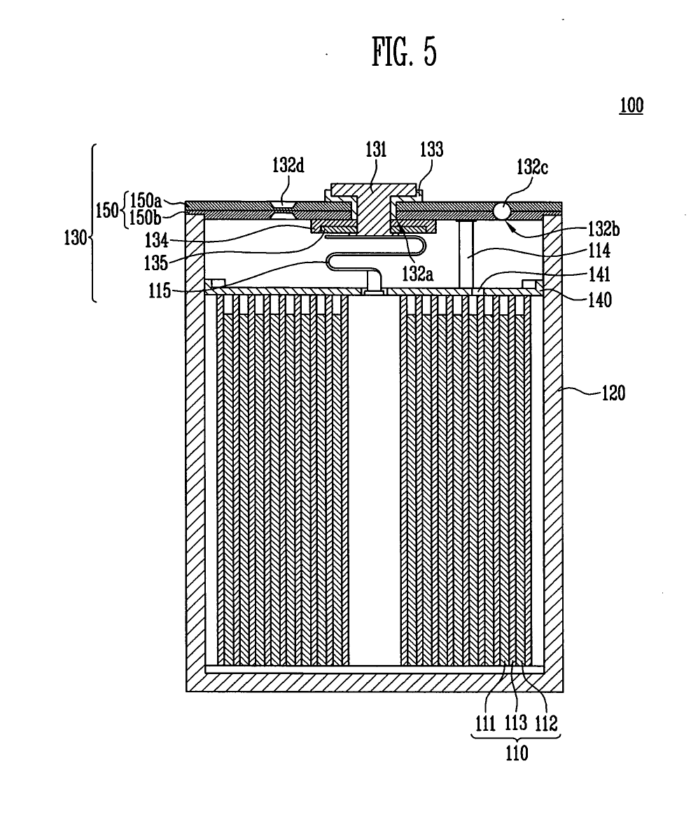

For example, as illustrated in FIG. 5, the cap plate 150 may include an upper layer 150a, e.g., including nickel, and a lower layer 150b, e.g., including aluminum. For example, the upper and lower layers 150a and 150b may be combined into a single clad metal layer. The lower layer 150b may be between the upper layer 150a and the insulating case 140, e.g., the lower layer 150b may directly contact the can 120 for sealing purposes. The upper layer 150a may be on, e.g., directly on, the lower layer 150b, and may completely overlap the lower layer 150b. The upper layer 150a may define a top surface of the cap plate 150, and may be connected to the lead plate 300, as illustrated in FIG. 4.

Referring to FIG. 4, the lead plate 300, e.g., may be divided into an anode lead plate and a cathode lead plate, may be connected between the cap plate 150 and the protective circuit module 200. For example, one side of the lead plate 300, i.e., the anode lead plate, may be connected to the protective circuit module 200 and the other side of the lead plate 300 may be connected to the upper metal layer 150a of the cap plate 150. These connections may be performed, e.g., by a screw joining method, a laser welding method, and/or a resistance welding method. A cathode lead plate 300a of the lead plate 300 may be connected between the electrode terminal 131 of the bare cell 100 and the protective circuit module 200. The upper layer 150a and the lead plate 300 may be made of the same material.

The cap plate 150 including the upper layer 150a and the lower layer 150b according to example embodiments may have increased strength and rigidity, e.g., as compared to a conventional cap plate. In particular, using a same material, e.g., nickel or nickel alloy, for forming the upper layer 150a and the lead plate 300 may improve and strengthen a connection therebetween. Further, a connection between the protective circuit module 200 and the bare cell 100 via the lead plate 300 and the cap plate 150 may be simplified and strengthened by using a simple resistance welding, e.g., as opposed to laser welding. Moreover, formation of the cap plate 150 of a clad metal layer may simplify its manufacturing process and reduce thickness of the battery pack and the number of components therein. In contrast, when a conventional lead cap, e.g., an anode lead cap, and a cap plate made of different materials, e.g., nickel and aluminum respectively, are connected to each other, a coupling force therebetween may be weak, e.g., satisfactory drop reliability may not be secured at a drop test, and resistance welding cannot be used for connection therebetween, e.g., because aluminum has a low resistance.

The protective circuit module 200 may be electrically connected with the bare cell 100. In the electrical connection of the protective circuit module 200 and the bare cell 100, as illustrated in FIG. 4, the protective circuit module 200 may be connected with the electrode terminal 131, i.e., a cathode of the bare cell 100, via the cathode lead plate 300a of the lead plate 300. An anode of the protective circuit module 200 may be electrically connected with the electrode assembly 110, i.e., an anode of the bare cell 100, via an anode of the lead plate 300. As illustrated in FIG. 2, a PTC element 300a1 may be electrically connected between the cathode of the protective circuit module 200 and the electrode terminal 131. Therefore, it may be possible to interrupt electrical connection between the cathode of the protective circuit module 200 and the electrode terminal 131 when excessive temperature increases or excessive current flows.

As further illustrated in FIG. 2, the protective circuit module 200 may include an insulating substrate 221, a printed circuit pattern (not shown), a conductive pad 223, a protection circuit unit 224, and a charging/discharging terminal 225. The conductive pad 223, the protection circuit unit 224, and the charging/discharging terminal 225 may be soldered to the printed circuit pattern formed on the insulating substrate 221. Herein, in the protection circuit unit 224, passive elements, e.g., a resistor and a condenser, an active element, e.g., a field effect transistor, a safety element, e.g., the PTC element 131a1, and integrated circuits may be selectively formed. Further, the protection circuit unit 224 may charge or discharge the bare cell 100, may prevent the life-span of the bare cell 100 from being deteriorated, and may prevent the bare cell 100 from being overheated and exploded by blocking charging and discharging paths of the bare cell 100 in response to excess heat or current flow.

As further illustrated in FIG. 2, the bare cell 100 may be covered by a subsidiary case 170, such that an edge portion may be protected from external impact. A double-sided tape 171 may be formed between the subsidiary case 170 and the bare cell 100, such that the subsidiary case 170 may be coupled with the bare cell 100.

As illustrated in FIGS. 1 and 2, the coupling case 400 may cover the protective circuit module 200 connected to the bare cell 100, and may be coupled with the bare cell 100 in the upper part thereof. When the coupling case 400 is coupled with the bare cell 100, a space, e.g., for the protective circuit module 200, may be formed in the coupling case 400 so as to cover the protective circuit module 200.

According to embodiments, it may be possible to reinforce the rigidity of a cap plate by attaching the cap plate formed by a clad metal layer onto the top of a bare cell. Further, the bare cell may be easily connected to a protective circuit module via the cap plate using simple resistance welding, e.g., as opposed to laser welding, thereby increasing a joining force therebetween. In addition, it may be possible to achieve process simplification by reducing the thickness of a pack and the number of components through forming a cap plate by a clad metal layer.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A rechargeable battery, comprising:
a bare cell;
a protective circuit module;
a lead plate connecting the protective circuit module with the bare cell; and
a cap plate in a top of the bare cell, the cap plate including at least one clad metal layer.

2. The secondary battery as claimed in claim 1, wherein the lead plate is connected to the bare cell via the clad metal layer of the cap plate.

3. The secondary battery as claimed in claim 2, wherein the lead plate and the clad metal layer of the cap plate include a substantially same material.

4. The secondary battery as claimed in claim 3, wherein the clad metal layer includes lower and upper layers formed of different materials, the upper layer contacting the lead plate and including a substantially same material as the lead plate.

5. The secondary battery as claimed in claim 2, wherein the clad metal layer completely overlaps a portion of the lead plate contacting the cap plate.

6. The secondary battery as claimed in claim 1, wherein the clad metal layer of the cap plate includes an aluminum metal layer and an additional metal layer on the aluminum metal layer, the aluminum metal layer overlapping an entire top of the bare cell.

7. The secondary battery as claimed in claim 6, wherein the aluminum metal layer is between the additional metal layer and the bare cell, and the additional metal layer including a different metal than aluminum.

8. The secondary battery as claimed in claim 7, wherein the lead plate is connected to the additional layer, the lead plate and the additional layer including a substantially same material.

9. The secondary battery as claimed in claim 8, wherein the additional layer overlaps an entire portion of the lead plate contacting the cap plate.

10. The secondary battery as claimed in claim 6, wherein the additional metal layer completely overlaps the aluminum layer.

11. The secondary battery as claimed in claim 6, wherein the lead plate is an anode lead plate, the anode lead plate being connected between the protective circuit module and the additional layer.

12. The secondary battery as claimed in claim 1, further comprising a cathode lead plate connected between an electrode terminal of the bare cell and the protective circuit module.

13. The secondary battery as claimed in claim 1, further comprising a coupling case covering the top of the bare cell, the protective circuit module, and the lead plate.
